(19) United States
(12) Patent Application Publication
(10) Pub. No.: US 2024/0270271 A1
(43) Pub. Date: Aug. 15, 2024

(54) INFORMATION PROCESSING DEVICE

(71) Applicant: TOYOTA JIDOSHA KABUSHIKI KAISHA, Toyota-shi (JP)

(72) Inventors: Hiroto HAMADA, Mitoshi-shi (JP); Miki TSUJINO, Nagakute-shi (JP); Masashi HATANAKA, Toyota-shi (JP); Makoto KONISHI, Nisshin-shi (JP)

(73) Assignee: TOYOTA JIDOSHA KABUSHIKI KAISHA, Toyota-shi (JP)

(21) Appl. No.: 18/504,556

(22) Filed: Nov. 8, 2023

(30) Foreign Application Priority Data
Feb. 13, 2023 (JP) 2023-020282

(51) Int. Cl. B60W 50/14; B60K 35/00

(52) U.S. Cl. CPC B60W 50/14; B60K 35/00; B60K 35/28; B60K 35/29; B60K 2360/171; B60K 2360/1868; B60W 2050/146; B60W 2554/4041; B60W 2554/80

(57) ABSTRACT

An information processing device includes a control unit configured to, when a target object that is present in a direction of travel of a vehicle traveling on a road is detected by a detection unit and a positional relationship between the vehicle and the target object is in a predetermined state, cause a display unit mounted in the vehicle and displaying a vehicle image showing the vehicle to display, at a position reflecting the positional relationship, a target object image showing the target object.

### CROSS-REFERENCE TO RELATED APPLICATION

This application claims priority to Japanese Patent Application No. 2023-020282 filed on Feb. 13, 2023, incorporated herein by reference in its entirety.

### BACKGROUND

### 1. Technical Field

The present disclosure relates to information processing devices.

### 2. Description of Related Art

WO2020/031912 discloses a technique that allows an occupant of a vehicle to clearly see a target object that is present outside the vehicle.

### SUMMARY

In the technique of WO2020/031912, target object-related information indicating a target object is displayed on a head-up display (HUD). However, this technique has room for improvement in terms of the content to be displayed on an in-vehicle display in order to make the occupant aware of the target object that is present outside the vehicle.

It is therefore an object of the present disclosure to provide an information processing device that allows an occupant of a vehicle to grasp the positional relationship between the vehicle and a target object through an in-vehicle display.

An information processing device according to one aspect of the present disclosure includes
a control unit configured to, when a target object that is present in a direction of travel of a vehicle traveling on a road is detected by a detection unit and a positional relationship between the vehicle and the target object is in a predetermined state, cause a display unit mounted in the vehicle and displaying a vehicle image showing the vehicle to display, at a position reflecting the positional relationship, a target object image showing the target object.

In the information processing device according to the above aspect,
when a target object is detected by the detection unit and the positional relationship between the vehicle and the target object is in the predetermined state, the control unit causes the display unit displaying the vehicle image to display the target object image at the position reflecting the positional relationship. In the information processing device, the display unit displays the target object image at the position reflecting the positional relationship between the vehicle and the target object. The information processing device thus allows the occupant to grasp the positional relationship between the vehicle and the target object through the in-vehicle display.

In the information processing device according to the above aspect,
the control unit may be configured to cause the display unit to display the vehicle image reflecting an actual state of the vehicle.

In the information processing device according to the above aspect,
the control unit causes the display unit to display the vehicle image reflecting the actual state of the vehicle. The information processing device thus allows the occupant to grasp the actual state of the vehicle by looking at the display unit.

In the information processing device according to the above aspect,
the control unit may be configured to turn on a brake light in the vehicle image when a brake of the vehicle is applied.

In the information processing device according to the above aspect,
the control unit turns on the brake light in the vehicle image when the brake of the vehicle is applied. The information processing device thus makes the occupant aware that the brake is applied by looking at the display unit.

In the information processing device according to the above aspect,
the control unit may be configured to cause a turn signal light in the vehicle image to blink when a turn signal of the vehicle is on.

In the information processing device according to the above aspect,
the control unit causes the turn signal light in the vehicle image to blink when the turn signal of the vehicle is on. The information processing device thus makes the occupant aware that the turn signal of the vehicle is on by looking at the display unit.

In the information processing device according to the above aspect,
the control unit may be configured to cause the display unit to display a road image showing the road and to display in the road image the vehicle image and the target object image at positions reflecting the positional relationship.

In the information processing device according to the above aspect,
the control unit causes the display unit to display in the road image the vehicle image and the target object image at the positions reflecting the positional relationship. The information processing device thus allows the occupant to grasp, through the in-vehicle display, the positional relationship between the vehicle and the target object on the road on which the vehicle travels.

As described above, the information processing device according to the present disclosure allows an occupant of a vehicle to grasp the positional relationship between the vehicle and a target object through the in-vehicle display.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a block diagram showing the hardware configuration of a vehicle;

FIG. 2 is a block diagram showing an example of the functional configuration of the vehicle;

FIG. 3 is a flowchart showing the flow of control processing;

FIG. 4 is a first illustration showing a display example displayed on the display unit while the vehicle is running;

FIG. 5 is a second illustration showing a display example displayed on the display unit while the vehicle is running; and

FIG. 6 is a third illustration showing a display example displayed on the display unit while the vehicle is running.

### DETAILED DESCRIPTION OF EMBODIMENTS

A vehicle 10 according to this embodiment will be described. The vehicle 10 may be an engine vehicle, a hybrid electric vehicle, or a battery electric vehicle, but in the present embodiment, the vehicle 10 is an engine vehicle as an example.

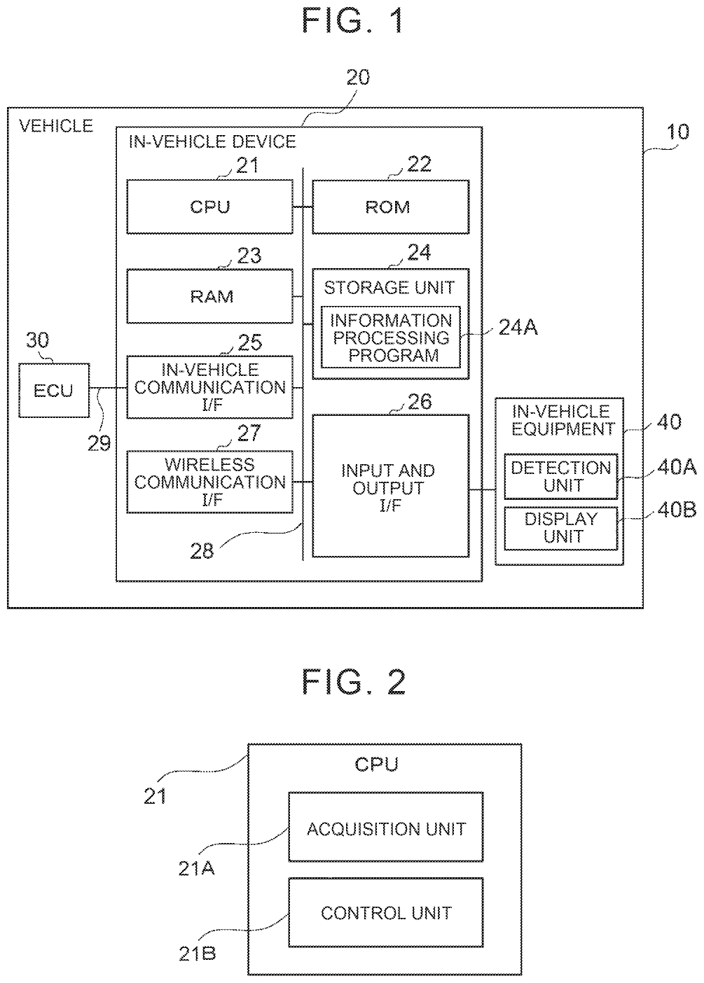

FIG. 1 is a block diagram showing the hardware configuration of the vehicle 10. As shown in FIG. 1, the vehicle 10 includes an in-vehicle device 20, an Electronic Control Unit (ECU) 30, and in-vehicle equipment 40. The in-vehicle device 20 is an example of an “information processing device.”

The in-vehicle device 20 includes a Central Processing Unit (CPU) 21, a Read Only Memory (ROM) 22, a Random Access Memory (RAM) 23, a storage unit 24, an in-vehicle communication Interface (I/F) 25, an input/output I/F 26, and wireless communication I/F 27. The CPU 21, ROM 22, RAM 23, storage unit 24, in-vehicle communication I/F 25, input/output I/F 26, and wireless communication I/F 27 are connected via an internal bus 28 so as to be able to communicate with each other.

The CPU 21 is a central processing unit that executes various programs and controls each section. That is, the CPU 21 reads a program from the ROM 22 or the storage unit 24 and executes the program using the RAM 23 as a work area. The CPU 21 performs control of the above components and various arithmetic processing according to programs recorded in the ROM 22 or the storage unit 24.

The ROM 22 stores various programs and various data. RAM 23 temporarily stores programs or data as a work area.

The storage unit 24 is configured by a storage device such as an embedded Multi Media Card (eMMC) or Universal Flash Storage (UFS), and stores various programs and various data. The storage unit 24 stores an information processing program 24A for causing the CPU 21 to execute control processing, which will be described later.

The in-vehicle communication I/F 25 is an interface for connecting with the ECU 30. The interface uses a communication standard based on the CAN protocol. In-vehicle communication I/F 25 is connected to external bus 29. Although not shown, a plurality of ECUs 30 is provided for each function of the vehicle 10. For example, the ECU 30 includes a turn signal ECU that controls to cause a turn signal light indicating a change in direction of travel to blink or turn off in response to the operation of a turn signal switch by an occupant (driver), and a brake ECU that controls the braking force to be applied to the vehicle 10 and controls the brake lights to turn on or off.

The input and output I/F 26 is an interface for communicating with the in-vehicle equipment 40 mounted on the vehicle 10.

The in-vehicle equipment 40 is various devices mounted on the vehicle 10.

The vehicle 10 includes a detection unit 40A and a display unit 40B as an example of the in-vehicle equipment 40.

The detection unit 40A is a detection device capable of detecting the state of the vehicle 10 including inside and outside the vehicle. As an example, the detection unit 40A includes a camera, a vehicle speed sensor, a millimeter wave sensor, and a Global Positioning System (GPS) device.

A camera as the detection unit 40A is, for example, an imaging device that performs imaging using an imaging element such as a Charge Coupled Device (CCD) image sensor or a Complementary Metal Oxide Semiconductor (CMOS) image sensor. The camera is provided in the front part of the vehicle 10 and images the front of the vehicle. The image captured by the camera is used, for example, to recognize the inter-vehicle distance from a preceding vehicle traveling in front of the vehicle, lanes, and objects present in front of the vehicle. Images captured by the camera are stored in the storage unit 24. Note that the camera may be configured as an imaging device for other uses such as a drive recorder and an Advanced Driver Assistance System (ADAS). Moreover, the camera may be connected to the in-vehicle device 20 via the ECU 30 (for example, camera ECU).

A vehicle speed sensor as the detection unit 40A is a sensor for detecting the vehicle speed of the vehicle 10, and is provided, for example, in the wheels.

A millimeter wave sensor as the detection unit 40A is a sensor for detecting a target object that is present in front the vehicle, that is, in the direction of travel of the vehicle 10, and is provided at least in the front part of the vehicle 10. The millimeter wave sensor is used to detect a target object by transmitting a transmission wave forward of the vehicle 10 and receiving a reflected wave from a target object in front. The target object is any object that may pose a danger to traveling of the vehicle 10, such as a pedestrian, a bicycle, a wall, an oncoming vehicle. Objects to be a target object may be registered in advance in the vehicle 10, or may be registered by input from the occupant. Moreover, it is desirable that the objects to be a target object can be updated by deletion, addition, etc. either automatically by the in-vehicle device 20 or based on the input from the occupant.

A GPS device as the detection unit 40A is a device that detects the current location of the vehicle 10. The GPS device includes an antenna (not shown) that receives signals from GPS satellites. The GPS device may be connected to the in-vehicle device 20 via a car navigation system connected to the ECU 30 (for example, a multimedia ECU).

The display unit 40B is an in-vehicle display for displaying an operation suggestion related to the function of the vehicle 10, an image related to the description of the function, and the like. The display unit 40B is provided on a meter panel as an example.

A wireless communication I/F 27 is a wireless communication module for communicating with the outside. The wireless communication module uses communication standards such as 5G, LTE, Wi-Fi (registered trademark), for example.

Next, the functional configuration of the vehicle 10 will be described. FIG. 2 is a block diagram showing an example of the functional configuration of the vehicle 10.

As shown in FIG. 2, the CPU 21 of the in-vehicle device 20 has an acquisition unit 21A and a control unit 21B as functional configurations. Each functional configuration is realized by the CPU 21 reading out the information processing program 24A stored in the storage unit 24 and executing it.

The acquisition unit 21A periodically acquires detection information detected by the detection unit 40A while the vehicle 10 is running. The detection information includes, for example, an image captured by a camera and detection results detected by a vehicle speed sensor, a millimeter wave sensor, and a GPS device. Further, the acquisition unit 21A periodically acquires vehicle information about the vehicle 10 from the ECU 30 while the vehicle 10 is running. The vehicle information includes, for example, the operating state of the turn signal switch, the on-off state of turn signal lights, the operating state of a brake pedal, and the on-off state of brake lights.

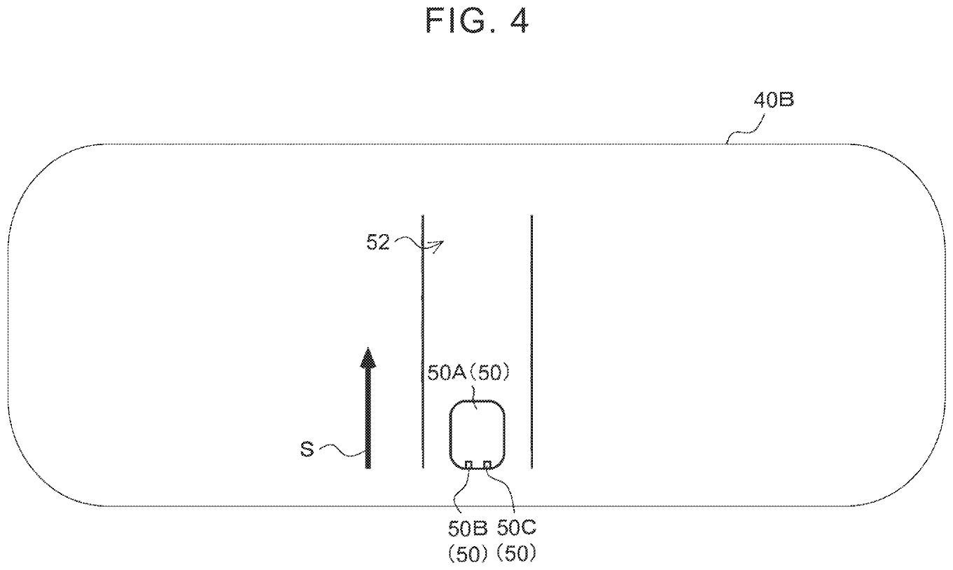

The control unit 21B controls the display content of the display unit 40B based on the detection information and the vehicle information acquired by the acquisition unit 21A. For example, while the vehicle 10 is traveling, the control unit 21B can cause the display unit 40B to display the vehicle image 50 showing the vehicle 10, the road image 52 showing the road on which the vehicle 10 travels, and the target object image 54 showing the target object, based on the detection information and the vehicle information (see FIGS. 4, 5, and 6).

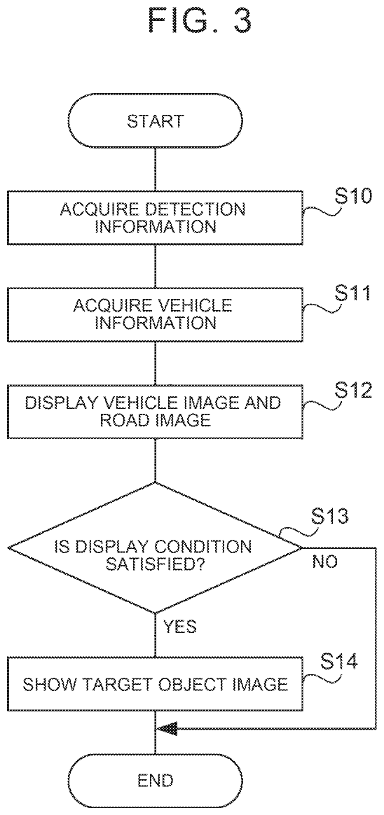

FIG. 3 is a flowchart showing the flow of control processing in which the in-vehicle device 20 controls the display content of the display unit 40B. Control processing is performed by the CPU 21 reading out the information processing program 24A from the storage unit 24, developing it in the RAM 23, and executing it. As an example, the control process shown in FIG. 3 is periodically executed while the vehicle 10 is running.

In S10 shown in FIG. 3, the CPU 21 acquires detection information detected by the detection unit 40A. Then, the CPU 21 proceeds to S11.

In S11, the CPU 21 acquires vehicle information from the ECU 30. Then, the CPU 21 proceeds to S12.

At S12, the CPU 21 causes the display unit 40B to display the vehicle image 50 and the road image 52 based on the detection information acquired at S10 and the vehicle information acquired at S11. Specifically, the CPU 21 causes the vehicle image 50 to be displayed at a position reflecting the actual position of the vehicle 10 in the road image 52. For example, when the vehicle 10 is traveling on the left side of the road, the CPU 21 displays the vehicle image 50 on the left end of the road image 52. Also, the CPU 21 displays a vehicle image 50 reflecting the actual state of the vehicle 10. For example, the CPU 21 turns on the brake lights in the vehicle image 50 when the brakes of the vehicle 10 are applied. Then, the CPU 21 proceeds to S13.

In S13, the CPU 21 determines whether or not the display condition is satisfied based on the detection information acquired in S10. When the CPU 21 determines that the display condition is satisfied (S13: YES), the process proceeds to S14. On the other hand, when the CPU 21 does not determine that the display condition is satisfied (S13: NO), it ends the control process. In the present embodiment, the CPU 21 determines that the display condition is satisfied when the target object that is present in the direction of travel of the vehicle 10 is detected by the detection unit 40A and the positional relationship between the vehicle 10 and the target object is in the predetermined state. In the present embodiment, when the positional relationship between the vehicle 10 and the target object is in a predetermined state, it means when the relative collision time divided by the relative speed between the vehicle 10 and the target object, so-called Time to Collision (TTC), is a predetermined value or less. The CPU 21 calculates the TTC between the vehicle 10 and the target object using the distance and relative speed between the vehicle 10 and the target object as the detection results of the millimeter wave sensor that is the detection unit 40A.

In S14, the CPU 21 causes the display unit 40B to display the target object image 54 based on the detection information acquired in S10. Specifically, the CPU 21 causes the target object image 54 to be displayed in the road image 52 at a position reflecting the positional relationship between the vehicle 10 and the target object. For example, when the actual position of the target object is outside the road, the CPU 21 displays the target object image 54 at a position indicating the outside of the road in the road image 52. Then, the CPU 21 terminates the control process.

Next, a display example displayed on the display unit 40B as a result of the control processing shown in FIG. 3 being performed by the in-vehicle device 20 will be described.

FIG. 4 is a first illustration showing a display example displayed on the display unit 40B while the vehicle 10 is traveling. Specifically, FIG. 4 is a display example of the display unit 40B when the vehicle 10 is traveling on a straight road.

The display unit 40B shown in FIG. 4 displays a vehicle image 50 showing the vehicle 10 traveling in the direction of the arrow S, and a road image 52 showing the straight road on which the vehicle 10 travels. As an example, the vehicle image 50 includes a substantially rectangular vehicle body portion 50A, and substantially square light portions 50B, 50C. In the road image 52, the area between two straight lines is the inside of the road, and the outside of the two straight lines is outside the road.

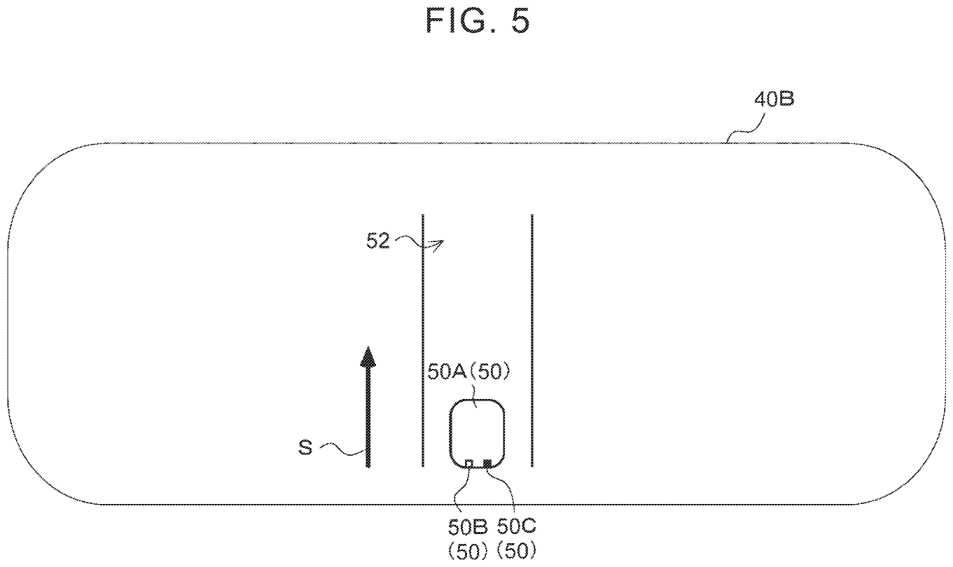

FIG. 5 is a second illustration showing a display example displayed on the display unit 40B while the vehicle 10 is running. Specifically, FIG. 5 is a display example of the display unit 40B after a predetermined time has elapsed since the display example shown in FIG. 4 was displayed.

The CPU 21 causes a turn signal light in the vehicle image 50 to blink when the turn signal of the vehicle 10 is on. As an example, in the present embodiment, the light portion 50B and the light portion 50C in the vehicle image 50 indicates the off state when the color inside the frame is white, indicates the on state when the color inside the frame is black. Therefore, the CPU 21 notifies blinking of the turn signal light in the vehicle image 50 by changing the color inside the frame of the light portion 50B or the light portion 50C to white or black at predetermined time intervals. The display unit 40B shown in FIG. 5 shows the case where the turn signal on the right side of the vehicle is on, and the color inside the frame of the light portion 50C changes from black to white after a predetermined time.

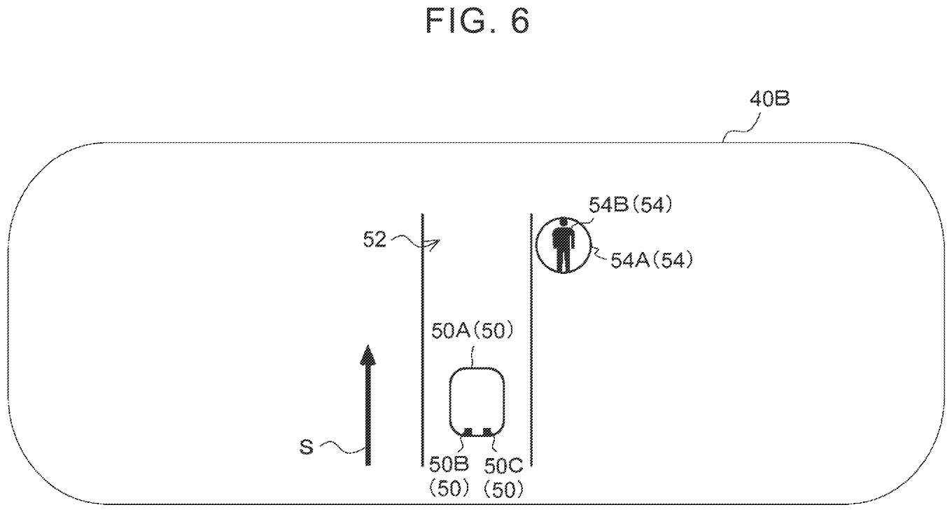

FIG. 6 is a third illustration showing a display example displayed on the display unit 40B while the vehicle 10 is running. Specifically, FIG. 6 is a display example of the display unit 40B after a predetermined time has elapsed since the display example shown in FIG. 5 was displayed.

The CPU 21 changes the vehicle image 50 and the road image 52 following changes in the actual position of the vehicle 10. Accordingly, in FIG. 6, the position of the vehicle image 50 has changed from the position in FIG. 5 to an upper position in the figure as the vehicle 10 has traveled straight on a straight road. Although not shown in the figure, when the vehicle 10 enters a curved road from a straight road, the CPU 21 changes the two straight lines of the road image 52 into two curved lines.

Further, the display unit 40B shown in FIG. 6 displays a target object image 54 in addition to the vehicle image 50 and the road image 52 as the CPU 21 determines that the display condition is satisfied. The target object image 54 reflects the actual positional relationship between the vehicle 10 and the target object, and is displayed outside the road on the right side of the vehicle image 50 in the drawing on the forward side in the direction of travel of the vehicle 10.

As an example, the target object image 54 is composed of a circular frame portion 54A and an icon 54B displayed within the frame portion 54A and indicating the type of the target object. In this embodiment, a plurality of types of icons 54B are provided, and the icon 54B selected by the CPU 21 based on the acquired detection information is displayed within the frame portion 54A. In FIG. 6, an icon 54B representing a pedestrian is displayed.

The CPU 21 turns on the brake lights in the vehicle image 50 when the brakes of the vehicle 10 are applied. In the present embodiment, the CPU 21 notifies turning on of the brake lights in the vehicle image 50 by changing the color inside the frame of the light portion 50B and the light portion 50C to black. Therefore, in the display unit 40B shown in FIG. 6, the area inside the frame of the light portion 50B and the light portion 50C is displayed in black to indicate that the brakes of the vehicle 10 are applied.

As described above, when a target object is detected by the detection unit 40A and the positional relationship between the vehicle 10 and the target object is in a predetermined state, the CPU 21 of the in-vehicle device 20 causes, as a function of the control unit 21B, the display unit 40B displaying the vehicle image 50 to display the target object image 54 at a position reflecting the positional relationship. Accordingly, in the in-vehicle device 20, the display unit 40B displays the target object image 54 at a position reflecting the positional relationship between the vehicle 10 and the target object. This allows the occupant to grasp the positional relationship between the vehicle 10 and the target object through the in-vehicle display.

In the in-vehicle device 20, the CPU 21 displays a vehicle image 50 reflecting the actual state of the vehicle 10 as a function of the control unit 21B. The in-vehicle device 20 thus allows the occupant to grasp the actual state of the vehicle 10 by looking at the display unit 40B.

In the in-vehicle device 20, the CPU 21, as a function of the control unit 21B, turn on the brake lights in the vehicle image 50 when the brakes of the vehicle 10 are applied. The in-vehicle device 20 thus makes the occupant aware that the brakes of the vehicle 10 are applied by looking at the display unit 40B.

In the in-vehicle device 20, the CPU 21 causes, as a function of the control unit 21B, a turn signal light in the vehicle image 50 to blink when the turn signal of the vehicle 10 is on. The in-vehicle device 20 thus makes the occupant aware that the turn signal of the vehicle 10 is on by looking at the display unit 40B.

In the in-vehicle device 20, the CPU 21 displays, in the road image 52, the vehicle image 50 and the target object image 54 at positions reflecting the positional relationship between the vehicle 10 and the target object as a function of the control unit 21B. The in-vehicle device 20 thus allows the occupant to grasp, through the in-vehicle display, the positional relationship between the vehicle 10 and the target object on the road on which the vehicle 10 travels.

### Others

In the above embodiment, the in-vehicle device 20 is illustrated an example of the information processing device. However, the present disclosure is not limited to this. An external device that is not mounted on the vehicle 10, such as a server, may be an example of the information processing device, or a combination of the in-vehicle device 20 and the external device may be an example of the information processing device. For example, when the combination of the in-vehicle device 20 and the external device is an example of the information processing device, at least part of the functional configurations of the CPU 21 of the in-vehicle device 20 shown in FIG. 2 may be performed by a CPU of the external device. In this case, the control process shown in FIG. 3 is performed by one processor of the CPU 21 of the in-vehicle device 20 or the CPU of the external device or by a combination of a plurality of processors of the CPU 21 of the in-vehicle device 20 and the CPU of the external device.

In the above-described embodiment, the detection unit 40A includes a camera, a vehicle speed sensor, a millimeter wave sensor, and a GPS device, but the configuration of the detection unit 40A is not limited to this. For example, the detection unit 40A includes a millimeter wave sensor as a detection device that detects a target object that is present in the direction of travel of the vehicle 10, but a lidar laser imaging detection and ranging (LIDAR) may be used instead of or in addition to the millimeter wave sensor. In addition, the lidar may be used to detect a target object.

In the above embodiment, the display unit 40B is provided on the meter panel, but the arrangement of the display unit 40B inside the vehicle is not limited to this. For example, the display unit 40B may be provided on an instrument panel, or configured as a HUD that illuminates the display surface of the front windshield.

In the above embodiment, the display unit 40B is a display device provided in the vehicle 10. However, the display unit 40B is not limited to this. A mobile terminal such as a smartphone of the occupant may be installed in the vehicle and used as the display unit 40B.

In the above embodiment, when the positional relationship between the vehicle 10 and the target object is in the predetermined state, it means when the TTC between the vehicle 10 and the target object is equal to or less than a predetermined value. However, the present disclosure is not limited to this. Alternatively, when the positional relationship between the vehicle 10 and the target object is in the predetermined state, it may means, for example, when the distance between the vehicle 10 and the target object is equal to or less than a predetermined value.

In the above embodiment, an example in which the brakes of the vehicle 10 are applied or the turn signal of the vehicle 10 is on is illustrated as an example of displaying the vehicle image 50 that reflects the actual state of the vehicle 10. However, the actual state of the vehicle 10 that is reflected in the vehicle image 50 is not limited to this. For example, if the doors or hatchback of the vehicle 10 are open, the CPU 21 may indicate that the doors or hatchback are open in the vehicle image 50, or if the vehicle 10 is damaged or dirty, the vehicle The image 50 may represent scratches, stains, or the like.

Note that the control processing executed by the CPU 21 by reading the software (program) in the above embodiment may be executed by various processors other than the CPU. In this case, the processor is a Programmable Logic Device (PLD) whose circuit configuration can be changed after manufacturing, such as a Field-Programmable Gate Array (FPGA), and an Application Specific Integrated Circuit (ASIC) for executing specific processing. A dedicated electric circuit or the like, which is a processor having a specially designed circuit configuration, is exemplified. The control processing may be performed by one of these various processors, or may be performed by a combination of two or more processors of the same type or different types (e.g., a plurality of FPGAs, a combination of a CPU and an FPGA, etc.). A hardware configuration of the various processors is, more specifically, an electric circuit composed of a combination of circuit elements such as semiconductor elements.

Further, in the above-described embodiment, the information processing program 24A is stored (installed) in advance in the storage unit 24, but the present disclosure is not limited to this. The information processing program 24A is provided in a form recorded in a recording medium such as a Compact Disk Read Only Memory (CD-ROM), a Digital

Versatile Disk Read Only Memory (DVD-ROM), and a Universal Serial Bus (USB) memory. Also, the information processing program 24A may be downloaded from an external device via a network.

What is claimed is:

1. An information processing device comprising a control unit configured to, when a target object that is present in a direction of travel of a vehicle traveling on a road is detected by a detection unit and a positional relationship between the vehicle and the target object is in a predetermined state, cause a display unit mounted in the vehicle and displaying a vehicle image showing the vehicle to display, at a position reflecting the positional relationship, a target object image showing the target object.

2. The information processing device according to claim 1, wherein the control unit is configured to cause the display unit to display the vehicle image reflecting an actual state of the vehicle.

3. The information processing device according to claim 2, wherein the control unit is configured to turn on a brake light in the vehicle image when a brake of the vehicle is applied.

4. The information processing device according to claim 2, wherein the control unit is configured to cause a turn signal light in the vehicle image to blink when a turn signal of the vehicle is on.

5. The information processing device according to claim 1, wherein the control unit is configured to cause the display unit to display a road image showing the road and to display in the road image the vehicle image and the target object image at positions reflecting the positional relationship.
